(19) United States
(12) Patent Application Publication
(10) Pub. No.: US 2005/0278245 A1
(43) Pub. Date: Dec. 15, 2005

(54) Method for measuring and managing risk taking into account human behavior

(76) Inventor: Luca Celati, London (GB)

Correspondence Address: SUGHRUE MION, PLLC, 2100 PENNSYLVANIA AVENUE, N.W., SUITE 800, WASHINGTON, DC, 20037, US

(21) Appl. No.: 10/865,950

(22) Filed: Jun. 14, 2004

(51) Int. Cl. G06F 17/60

(52) U.S. Cl. 705/38; 705/7

(57) ABSTRACT

A method of measuring and managing operational, credit and/or market risk within an organization with objective and subjective data. Psychometric and/or other personality assessment tools are applied to a selected group of people involved with the results being stored as subjective data in the measuring and management system along with objective data to be used in the production of at least one risk measure which is a measure of operational, credit and/or market risk.

### FIELD OF THE INVENTION

The present invention relates generally to risk management methods, and is more specifically directed to methods for measuring and managing operational, market and/or credit risks.

Several definitions have been proposed for the broad field of operational risk. The Basel Committee on Banking Supervision defines it as “the risk of direct or indirect loss resulting from inadequate or failed internal processes, people and systems or from external events”. This view includes legal risks but not strategic and reputational risks. Conversely, according to the UK Treasury on-line glossary, operational risk is “the risk of financial loss arising from the transaction, settlement and resource management processes associated with reserves and debt management.” This definition includes reputational risk.

### BACKGROUND OF THE INVENTION

Within the framework of systems and methods for measuring the risk capital adopted by e.g. banks and financial institutions, the use of objective, measurable data as as source for statistics is a consolidated practice. Known methods and processes of modeling operational risk are disclosed in U.S. Pat. Appl. No. 2003/0149657, which include for example the steps of defining one or more reporting hierarchies composed of operational units reflecting the structure of an organization, associating operational risk data to one or more of said operational units, wherein said operational risk data includes data associated with a plurality of first loss events, and calibrating a plurality of loss processes and a plurality of loss process attributes using said plurality of first loss events, wherein a plurality of loss processes are generated for use in at least one of risk management, operations management, and financial management. In the known systems, indicators are used as predictors of risk. These indicators are measurable and quantifiable numeric factors that may influence losses and they comprise, for example, data about the volume of transactions by a firm, the turnover of staff and availability of new technology, or even the age of each single person within every operational unit in which the firm is hierarchically organized. Numerical correlations between indicators and loss events can assist in calibrating loss distributions and the risk capital.

Modern methodologies of risk management have been developed on the basis of the theoretical model of Modern Finance Theory (MFT) and its well-known Efficient Market Hypothesis (EMH), which do not take into account the important human factor as a possible important variable for the definition of risk. The human factor is instead the basis of a different theoretical field known as Behavioral Finance. However developed and advanced, the studies and theoretical models developed by experts of Behavioral Finance have not yet found their way into the field of risk management, inherently because the consolidated procedures and methods which are adopted in order to measure and manage the risk capital only relate to objectively measurable quantities, as it has been discussed above.

An impressive body of studies in Behavioral Finance and Cognitive Psychology over the last twenty years has confirmed the existence and consistency in human biases. Nevertheless not much has been done to even measure—let alone manage—them. Accordingly, while recent emphasis—last but not least by regulators—on the area of operational risk has underscored how the human element is responsible for about two-thirds of operational losses, these statistics are nothing but ex-post effects of a deeper problem.

The broad conclusion from most operational risk surveys and investigations is that human error and processes accounts for about 75%-80% of losses and risk management problems. There is empirical evidence that human personality plays a determinant role in e.g. trading decisions and performance.

Amongst others, the London Business School has carried out extensive research since 1998 on over 1000 traders and trading managers in major investment banks. The research underscored strong correlation between performance and a psychological phenomenon called “illusion of control”. In addition, a significant correlation was found between performance and risk management awareness. Risk-taking attitudes and excitement-seeking behaviors derived from individual preferences outside work have also been found to offer good predictive power for one's behavior on the job. Other experimental research demonstrates correlation between psychophysiology and trading behavior.

### SUMMARY OF THE INVENTION

It is an aim of the present invention that of using psychometric factors—and data indicative of human personality of people involved which will be called subjective data hereinafter—to integrate the widely accepted practices of measuring market, credit or operational risk based on objective data, such as, for example, the volatility of risk factors associated with a security in a portfolio or the operational risk loss data such as illustrated in the example of aforesaid U.S. Patent Appl. No. 2003/0149657.

In order to achieve the above mentioned aim, the present invention is directed to the use of psychometric tools for generating data indicative of people's behavioral drivers of performance. In particular, these data are used to complement the series of data defining persons involved in activities subjected to risk, to be subsequently introduced into a system for managing operational, market and credit risk along with operational risk and other objective data including data and parameters associated with a plurality of loss events, a plurality of loss processes, and a plurality of loss process attributes being then generated for further processing in order to derive at least one risk measure. Such attributes include but are not limited to the volatility of risk factors associated with securities, loans and all other positions involving market and credit risk. In the specific case of financial risk management, the present invention may easily provide new criteria to allocate risk capital based on the psychological composition of a population of risk-takers.

According to the invention, there is provided a method of measuring and managing operational, credit and/or market risk within an organization, comprising the steps of providing a measuring and management system of measuring risks with input means for inputting data and storing means for storing data, applying psychometric tools to a selected group of people involved, collecting results from the psychometric tools and deriving numerical scores representative of said results, inputting and storing said numerical scores as subjective data in said measuring and management system along with objective data to be used in the production of at least one risk measure, wherein said risk measure is a measure of operational, credit and/or market risk.

The collection of said subjective data indicative of human behavior, particularly of people's behavioral drivers of performance in a risk management framework, constitutes a psychometric portfolio which can be analyzed and managed for an organization as a whole, so as to give further indications as to the added risk that e.g. key personality traits be over- or under-represented within the organization itself, information as to the key dimensions of the leader's personality in a hierarchy or group and an assessment of how much diversity exists in the groups or units led by said leader.

Although the present invention can make use of any psychometric or personality assessment tool which is adapted to numerically represent the various components which influence and drive human behavior, the present invention has been developed with particular reference to commonly accepted and scientifically validated psychometric tests. While a preferred—and scientifically validated—psychometric test of this kind is the International Personality Item Pool (IPIP) Representation of the NEO PI-R™ test, the present invention can be adapted so as to make use of other commonly accepted and scientifically validated psychometric tests such as for example NPI™ or Myers-Briggs MBTI™ test.

Further characteristics and advantages will become clearer from the following detailed description of a preferred embodiment and further embodiments of the present invention.

### DETAILED DESCRIPTION OF THE INVENTION

The present invention is adapted to work in conjunction with known risk management systems and methods, which in particular make use of objective data to measure market, credit or operational risk. These data, preferably a time series thereof, are usually collected and stored in a database system as numeric factors to be used as indicators or predictors of risk. Numerical correlations between these data and loss processes are then defined within the known risk management systems in known ways to arrive at the measurement and management of market, credit or operational risk. The details of measurement and management of risk in known systems go beyond the scope of the present invention and therefore will not be discussed in further detail. The method of the present invention includes the step of numerically representing the various components which influence and drive human behavior of the people involved, in order to generate a set of subjective data to be stored along said set of objective data, preferably in the same database system. This step can be conducted, for example, by interviewing people involved according to the methodology set forth by a psychometric test, more preferably a scientifically validated psychometric test such as the International Personality Item Pool (IPIP) Representation of the NEO PI-R™ test. Interviews can be substituted or complemented by collecting forms filled in by the people involved, preferably by means of a computerized system.

As a non-limiting example, according to the above-mentioned specific test, five basic dimensions of personality are defined, that is Openness to Experience, Conscientiousness, Extraversion, Agreeableness, Neuroticism, each of which can be further subdivided into several more facets. The result of the test gives an absolute score which can be than compared to a population average score. This comparison is important because it allows a normalization of the score with respect to a selected population, which usually does not show an even distribution of score and for which the average score is usually different from the mathematical one. If for example, each dimension has a possible absolute score that ranges between 0 and 100, that does not mean that the average score for a given population is 50, but it might well be—and usually is—below or above that value.

According to a particular aspect of the present invention, the reference population against which the absolute scores are compared can be preventively selected according to one or more of several parameters, comprising for example age, location, origin, education level of the various persons which form the overall population of people who took the test.

The normalized scores are then stored as subjective data for further processing in a known risk management system along with objective data. The normalized scores further constitute a psychometric portfolio which can be analyzed and managed for an organization as a whole through e.g. statistical tools, so as to give further indications as to various qualitative components or elements of risk, under-represented within the organization itself, or correlations between the said personality traits and P&L/loss distributions.

The present invention has been described with regard to specific embodiments. However, it will be obvious to persons skilled in the art that a number of variants and modifications can be made without departing from the scope and spirit of the invention defined in the claims appended thereto.

1. A method of measuring and managing operational, credit and/or market risk within an organization, comprising the steps of providing a measuring and management system of measuring risks with input means for inputting data and storing means for storing data, applying psychometric and/or other personality assessment tools to a selected group of people involved, collecting results from the psychometric tools and deriving numerical scores representative of said results, inputting and storing said numerical scores as subjective data in said measuring and management system along with objective data to be used in the production of at least one risk measure, wherein said risk measure is a measure of operational, credit and/or market risk.

2. A method according to claim 1, wherein the psychometric and other personality assessment tools are selected among the group comprising scientifically validated psychometric tests.

3. A method according to claim 1, further comprising the steps of defining a population with aggregate average scores, comparing said numerical scores representative of said results of psychometric and other personality assessment tools to the aggregate average scores so as to define normalized numerical scores to be inputted as subjective data in said measuring and management system along with objective data.
